(19) United States
(12) Patent Application Publication
(10) Pub. No.: US 2014/0334621 A1
(43) Pub. Date: Nov. 13, 2014

(54) Method for Complete Atomic Blocks for Elliptic Curves in Jacobian Coordinates over Prime Fields Countermeasure for Simple-Side Channel Attacks and C-Safe-Fault Attacks for Left-to-Right Algorithms

(71) Applicant: Universidad de Santiago de Chile, (US)

(72) Inventors: Rodrigo Abarzua, Santiago (CL); Nicolas Theriault, Santiago (CL)

(73) Assignee: Universidad de Santiago de Chile, Sabtiago (CL)

(21) Appl. No.: 13/892,816

(22) Filed: May 13, 2013

(51) Int. Cl. G06F 7/72; H04L 9/08

(52) U.S. Cl. CPC G06F 7/725; H04L 9/0861
USPC 380/28

(57) ABSTRACT

The present invention describes a method which improves the safety aspects of the previously published atomic blocks. This method builds new sets of atomic blocks designed to protect against both simple side-channel attacks and C-safe fault attacks for scalar multiplication for elliptic curves over prime fields. These atomic blocks are structured with the sequence of field operations (S, N, A, A, M, A), Squaring, Negation, Addition, Addition, Multiplication, Addition. These atomic blocks are applied to various operations in Jacobian coordinates: doubling, tripling, and quintupling, as well as mixed Jacobian-affine addition for use in left-to-right scalar multiplication.

### BACKGROUND OF THE INVENTION

The invention relates to the safety technology field. Particularly, the present invention relates to atomic blocks for cryptosystems based on elliptic curves over finite fields of prime characteristic known as ECC-systems.

Elliptic Curves Cryptography (ECC) is a public-key cryptosystem proposed by Neal Koblitz [Koblitz87] and Victor Miller [Miller86] in 1985 which provides significant advantages in several situations, including implementations on specialized microprocessors. For example, some industry standards require 1024-bits for the size of integers in the RSA system, whereas the equivalent requirement for ECC is to work with finite fields of 160-bits. Given the restrictions on embedded microprocessors (used in mobile devices), the ECC system is an interesting option to obtain the required security.

Side-channel attacks exploit physical leakages of a cryptographic process on a device (using timing [Kocher96], power consumption [Kocher99] and electromagnetic radiation [Quisquater01, Gandolfi01]). These attacks present a realistic threat to cryptographic applications, and have been demonstrated to be very effective against smart cards without proper countermeasures. There are two general strategies with regard to these attacks: Simple Side-channel Analysis (SSCA) [Kocher96] which analyses the measurements of a single scalar multiplication, observing the differences in the behavior of the scalar multiplication depending on the value of the secret key; and Different Side-channel Analysis (DSCA) [Kocher99], which uses statistical techniques to retrieve information about the secret key based on the measurements from several scalar multiplications. This work will be focused on SSCA.

Several proposals have been made to protect scalar multiplication against these attacks. For example, the double-and-add-always algorithm of Coron [Coron99] ensures that the sequence of operations to compute a scalar multiplication is independent of the value of the secret scalar by inserting a dummy point addition between consecutive doublings (when the bit of the scalar is 0). A second countermeasure is to use unified formulae which use similar sets of field operations for both the general group additions and doublings. Such formulae exist for Edwards curves [Edwards07], inverted Edwards curves [Bernstein07], curves in the Huff model [Joye10], Hessian curves [Smart01], Jacobi curves [Liardet01, Billet02], Weierstrass elliptic curves [Brier02] (more details can be found in the database of special elliptic curves [Bernstein-Lange]). Another possible countermeasure is the Montgomery ladder [Montgomery97] designed for a special type of curve in large characteristic. As for the double-and-add-always algorithm, it makes sure that every bit of the scalar corresponds to both a doubling and an addition, but with the supplementary condition that both operations have an impact on the final output of the scalar multiplication. This was later generalized to all elliptic curves [LOpez99, Brier02, Goundar11], and right-to-left scalar multiplication Double-add of Joye's [Joye03] and zeroless signed-digit algorithm [Goundar11]. A fifth approach consists in using “regular” representations of the scalar [Moeller01, Theriault05, Joye07], with the same fixed sequence of group operations for all scalars. Finally, Side-Channel Atomicity (first proposed by Chevallier-Mames et al. [Chevallier04]) splits point operations into small homogeneous blocks of basic field operations. If it is carefully implemented, it becomes impossible to distinguish between atomic blocks coming from doublings or additions. Atomic blocks are potentially the most efficient SSCA countermeasure.

A number of refinements have been provided to the atomic blocks structure since the paper published by Chevallier-Mames et al. An early assumption in atomic blocks design was that field multiplication and squaring are indistinguishable to side-channel analysis [Chevallier04, Chen09, Giraud10], but it was later showed that the two operations can be distinguished even when they are equally treated by the processor [Amie109, Hanley11].

As a result, an efficient and secure atomic block should consider distinct squarings and multiplications in its structure. Applying such atomic blocks to existing formulae can be rather inefficient since several dummy operations have to be introduced. Both Longa and Miri [Longa08] and Bernstein and Lange [Bernstein07] presented a flexible methodology to modify group operations formulae to fit it better in atomic blocks that could distinguish between the two field operations, by turning some multiplications into squarings [Longa08].

The Jacobian coordinates formulae of Longa and Miri [Longa08] for left-to-right scalar multiplication can be considered the current best in atomic blocks formulae.

However, one problem has usually not been addressed in previous works on atomic blocks. If a group or field operation is introduced to provide side-channel uniformity but these operations do not affect the final output, then these “dummy” operations open the way to C-safe fault attacks [Yen00]. These attacks consist in introducing a fault in the scalar multiplication at a point corresponding to a suspected dummy operation, e.g. guessing what the next (non-dummy) group operation should be. If the final output is still valid, the guess was correct, whereas if the fault produces an error in the final output, then the guess was incorrect. Through this process, an attacker can obtain the secret scalar through observation of a few observations of the scalar multiplication.

As a result, it is recommended to avoid using dummy operations in the formulae [Avanzi05]. These attacks can be considered more closely related to DSCA than SSCA (although they are mathematically simpler than other DSCA), but they require far fewer observations than most other DSCA. The object matter of this invention is securing the atomic blocks formulae against C-safe fault attacks.

### Mathematical Background

For a detailed description of elliptic curves, see [Avanzi06, Washington08].

An elliptic curve E defined over a large prime field is GF(p) given by an equation of the form y²=x³+ax+b, with 4a³+27b²≠0. The group used for cryptography consists of the (affine) point (x,y) on the curve and the point at infinity “◯” (the neutral element), with the “chord-and-tangent” addition. The group operation for (p, q)+(r, s) is given by

(x,y)=(λ²−p−r,λ(p−x)−q)

where λ=(q−s)/(p−r) if p≠r (addition formula) and λ=(3p̂2+a)/(2q) if (p, q)=(r, s) (doubling formula) and (p, q)+(p, −q)=◯.

Jacobian coordinates are a projective representation of the points consisting of equivalence classes of the form:

(X:Y:Z)=(λ²X,λ³Y,λZ):λεGF(p) (1)

A Jacobian point (X:Y:Z) with Z≠0 corresponds to the affine point (x, y)=(X/Z², Y/Z³).

Curves with a=−3 offer better performance in Jacobian coordinates, so the curves will be restricted of the form, [NIST09 SECG].

E:y²=x³−3x+b

### Rescaling Methodology

The “rescaling” methodology presented by Longa and Miri [Longa08] and Bernstein and Lange [Bernstein07] takes advantage of the projective form of the point coordinates.

The principal idea consists in taking a field multiplication αβ, and replacing it with a number of field squarings, additions and negation

2αβ=(α+β)²−α²−β² (2)

If λ=2 in the class description (1), it can be easily seen how factors of 2 can be incorporated into all of the coordinates (in the invention, from the output of the computation). It can then replace the computation by equation (2) adjusting the remaining computations accordingly.

The technique presented in [Longa08, Bernstein07] can be summarized in two steps:

Replacing one (or more) of the field multiplications by applying the algebraic substitution given in Equation (2).

Modifying the point formula by inserting multiples of 2 in the point representation, using the equivalence (X:Y:Z)˜(2²X:2³Y:2Z).

### State of the Art for Atomic Blocks

In this section, a more detailed description of previous works on block-atomicity for elliptic curves for use in left-to-right scalar multiplication is presented.

Atomic blocks formulae are a very promising method to secure scalar multiplication against SSCA. The idea is first introduced by Chevallier-Manes et al. [Chevallier04] and consists in partitioning point operations into small homogeneous atomic blocks, which cannot be distinguished from each other through SSCA, thus making it impossible for the attacker to know which block is part of a group doubling or addition. Any field operation of an atomic block that is not used by the formula would be filled with dummy operations so that no missing operation would be identified by a SSCA. By staying “as close as possible” to the optimized formula, an atomic block formula can then provide the desired security at a much lower price than other SSCA countermeasures.

Chen et al. in [Chen09], presented an experimental attack on a smart card using an implementation of the atomic blocks proposed by Chevallier-Mames et al. [Chevallier04]. This experimental attacks utilizes the different number atomic blocks for group doublings and additions—for total operation times of 3.16 ms and 3.61 ms respectively—and a delay of 1.12 ms for breaks between group operations. This experimental attack is applied because the implementation does not avoid irregular breaks between atomic blocks within the same group operation and distinct group operations. Chen et al. proposed to balance the point doubling with respect to a group addition. A preferred option is to require a better management of the delays between atomic blocks, thus allowing for formulae with different numbers of blocks.

The original atomic block of Chevallier-Mames et al. had a structure of (M,A,N,A) (Multiplication-Addition-Negation-Addition) operations over the prime field. This atomic block made one important assumption: that multiplication and squaring are indistinguishable from a side-channel perspective. This was disproved by Amiel et al. [Amiel] and Hanley et al. [Hanley11]. Since the Hamming weight for the results of a field multiplication and squaring have different distributions, and the Hamming weight affects the side-channel traces, it is possible to use this difference to distinguish between blocks containing a general multiplication and those containing a squaring operation, re-opening the way to SSCA. As a consequence, atomic blocks should consider distinct squaring and multiplication in their structure.

This distinction can also have some efficiency benefits when considering that specialized squarings are less expensive than multiplication (at a ratio close to 0.8 in practice [Giraud]). In order to adapt the existing formulae to various atomic block structures, the flexible methodology introduced by Longa and Miri [Longa08], and Bernstein and Lange [Bernstein07] can prove very useful. It permits the modification of point operations formulae to balance the number of squarings and multiplication, thus facilitating the introduction of squarings into atomic blocks.

Longa and Miri presented a new atomic block structure based on the sequence Squaring-Negation-Addition-Multiplication-Negation-Addition-Addition of field operations or (S, N, A, M, N, A, A). They applied their atomic block structure to doubling, tripling and mixed addition for elliptic curves in Jacobian coordinates over prime fields. It should be noted that these atomic blocks formulae make use of dummy operations at one point or another at the very least to fill up some of the additions and/or negations.

### Atomic Blocks and C-Safe Attacks

As stated above, previously published atomic blocks formulae for elliptic curves defined over prime fields are open to C-safe fault attacks [Yen00]. Although most balanced formulae do fill out all the multiplications and squarings with non-dummy operations, no such consideration is applied to field additions and negations.

Experimental data on various smart cards [Giraud10] provide an addition-to-multiplication ratio close to 0.2 and a negation-to-multiplication ratio of 0.1. Even though the timing for these operations is much less than for multiplications and squarings (the squaring-to-multiplication ratio is usually close to 0.8), it would still be reasonable to mount a C-safe fault attack on dummy field additions and negations.

To address this weakness, a new set of operations formulae for point doublings, triplings and quintuplings in Jacobian coordinates as well as mixed Jacobian-affine addition formulae was created.

The only way to really avoid C-safe fault attacks is to ensure that every field operation of every atomic block is used in the computation of the final result. Note that it would not be sufficient to repeat the same operation more than once in the formula (using each result at least once), since the repeated operations would leave an essentially identical side-channel signature, thus re-opening the way to SSCA. Due to the aforementioned, all field operations of every atomic block must be filled but always with different operands.

It is, therefore, desirable to provide an improved method for complete atomic blocks for elliptic curves in jacobian coordinates over prime fields countermeasure for simple-side channel attacks and c-safe-fault attacks for left-to-right algorithms, which overcomes most, if not all of the preceding problems/disadvantages.

### BRIEF SUMMARY OF THE INVENTION

An improved method for complete atomic blocks for elliptic curves in jacobian coordinates over prime fields countermeasure for simple-side channel attacks and c-safe-fault attacks for left-to-right algorithms is provided.

The demand for wireless technology (cell phones, smart card) has significantly increased in recent years. Most of these devices rely on embedded microprocessors to secure the data being transmitted. Providing efficient cryptographic algorithms is a fundamental issue for the development of secure wireless devices.

One of the tools being investigated as a possible method to improve the security of these devices consists of public key cryptosystems, particularly cryptographic systems based on elliptic curves.

The present invention describes a method which improves the safety aspects of the previously published atomic blocks. This method builds new sets of atomic blocks designed to protect against both simple side-channel attacks and C-safe fault attacks for scalar multiplication for elliptic curves over prime fields. These atomic blocks are structured with the sequence of field operations (S, N, A, A, M, A), Squaring, Negation, Addition, Addition, Multiplication, Addition. These atomic blocks are applied to various operations in Jacobian coordinates: doubling, tripling, and quintupling, as well as mixed Jacobian-affine addition for use in left-to-right scalar multiplication.

As in previous atomic blocks formulae, the group operations of this invention provide protection against simple side channel attacks by dividing the group operations into smaller sequences of field operations. One of the main differences with other formulae resides in their security against C-safe fault attacks. Unlike previous works, the formulae of this method are designed to completely fill the atomic blocks with field operations that affect the final output (i.e. to avoid “dummy” operations) and are all distinct (none of the operations are repeated). They also have the added bonus of being slightly more “compact” than most previous atomic blocks, having fewer additions/negations for each multiplication/squaring, potentially providing a performance gain.

A compact and efficient solution is described that protects the scalar multiplication ([d]P) algorithm used in cryptosystems based on elliptic curves (ECC) from simple side-channel attacks [Kocher96, Kocher99] and C-Safe fault attacks [Yen00]. The described method has a compact structure in comparison to the existing solutions and specifically corresponds to the atomic structure: Squaring, Negation, Addition, Addition, Multiplication, Addition (S,N,A,A,M,A). If the cryptographic algorithm used to calculate the scalar multiplication reads the scalar in a left-to-right direction, the formulae present atomic blocks for Doubling (2P), Mixed-Jacobian Addition (P+Q), Tripling (3P) and Quintupling (5P). Algorithms of (3P) and/or (5P) are used if the scalar multiplication is implemented using multi-basis. Particularly, this invention is for elliptic curves defined over a prime field. The technique presented by Longa in [Longa08] and Bernstein-Lange [Bernstein07] is applied to balance multiplications and squarings in the previously indicated formulae in addition to the use of algebraic identities to eliminate “dummy” operations, which is a vulnerability present in all atomic blocks previously presented by the scientific community [Chevaliar04, Longa08, Chen09, Giraud10], wherein this vulnerability is used to apply C-safe fault attacks [Yen00]. Moreover, these blocks have a more compact structure than the existing atomic blocks, which results in a better computing performance.

### Method to Design the Atomic Blocks:

From the existing formulae (doubling [2]P, tripling 3[P], and quintupling 5[P], as well as mixed Jacobian-affine addition (P+Q)) determining that the most favorable form for the atomic blocks would be with 1S+1M (since most formulae were close to be balanced), with the squaring before the multiplication (due to the importance of squarings early in the formulae). Balancing the number of squarings and multiplications in the formula using the technique of Longa and Miri [Longa08] and Bernstein and Lange [Bernstein07]. Drawing a directed graph of the dependencies in the squarings and multiplications (ignoring the field additions and negations), and trying to create ordered pairs (Sᵢ,Mᵢ) (one squaring followed by one multiplication) allowing to go through the graph using each operation only once.

Starting with the ordered pairs (Sᵢ,Mᵢ), look for the minimal numbers of field additions and negations required to include the whole formula, and try to determine their respective position (being particularly focused on the first and last blocks since those tend to be the least flexible of the formula). This process leads to (S, N, A, A, M, A) blocks and a first version of the atomic block formulae as well, but they are not necessarily secured against C-safe fault attacks.

Using simple algebraic identities to fill all the “spaces” in the formulas, for example: computing 3a as 2a+a or 2(2a)−a, computing 4a as 2(2a) or 2a+a+a, careful positioning the negations (multiplications by −1).

In the following subsections, the resulting atomic blocks are described, providing protection against both simple side-channel attacks and C-safe fault attacks for use in left-to-right scalar multiplication.

A more detailed explanation of the invention is provided in the following detailed descriptions and appended claims taken in conjunction with the accompanying drawings.

### BRIEF DESCRIPTION OF THE DRAWINGS

FIG. 1 is a flow graph which describes how to use the different atomic blocks of the invention.

### DETAILED DESCRIPTION OF THE INVENTION

The following is a detailed description and explanation of the preferred embodiments of the invention and best modes for practicing the invention. The following methodology is used for generating the new atomic blocks of this invention.

The methodology is based on atomic blocks protecting against simple side-channel attacks (SSCA) and C-Safe fault attacks, eliminating the use of dummy operations in the scalar multiplication ([d]P), for cryptosystems based on elliptic curves defined over fields of prime characteristic, particularly for curves of the type y²=x³−3x+b with a, bεGF(p) and the discriminant Δ=4a³+27b²≠0(mod p). These curves are used by standards NIST [NIST09] and SECG [SECG].

In order to eliminate the dummy operations which can be subject to C-safe fault attacks, algebraic substitutions are used to write formulae of: Doubling ([2]P), Mixed-Addition (P+Q) (P en Jacobian coordinates and Q in affine coordinates), tripling ([3]P) and quintupling ([5]P), when the scalar multiplication is implemented with left-to-right algorithms. These atomic blocks have a compact and efficient atomic structure (S, N, A, A, M, A).

First of all, in order to build atomic blocks it is necessary to balance the number of multiplications and squarings using the method presented in [Longa08] and [Bernstein07]. Besides which, the new algebraic substitutions are employed to eliminate the use of “dummy” operations. From the balanced formulae in relation to the number of squarings (S) and multiplications (M), a graph of algebraic operations is generated (one for each of the previous algorithms: [2]P, mixed addition (P+Q), [3]P y [5]P) wherein said graph indicates the flow that must be executed for creating each one of the previous algorithms. This shows the dependencies of multiplications, squarings, additions and negations on the defining field of the elliptic curve to perform the calculation of algorithms.

As a result of the analysis of this directed graph containing dependency operations, ordered pairs (Sᵢ,Mᵢ) are created (a squaring followed by a multiplication per each atomic block). The minimum quantity of additions and negations required for each formula is enumerated, and each position thereof is determined by observing the directed graph containing the data dependency operations. A special case takes place in relation to the first and last atomic blocks considering they have less flexibility in the formulae or algorithms that will be presented in this invention.

Based on the minimum number of operations, the most efficient and compact structure possible is the structure (S, N, A, A, M, A) for all previously mentioned algorithms. The result is a more compact structure, enhancing the efficiency and safety aspects of all previously presented atomic blocks.

After determining the most efficient structure of these atomic blocks when using left-to-right algorithms for the scalar multiplication ([d]P), formulae and atomic blocks are written for the Doubling case ([2]P), as shown in Table 1.

Point Doubling in Jacobian Coordinates

Let P=(X1:Y1:Z1) be a point in Jacobian coordinates on the elliptic curve E. The most efficient doubling formula (with the output also in Jacobian coordinates) requires 4M+4S. In terms of multiplication and squaring, there is little change from previous formulae, however additions and negations were re-organized to fill the operations in the atomic blocks.

α=3(X₁+Z₁²)(X₁−Z₁²),

Z₃=2(Y₁Z₁),

Y₃=(−α)(X₃−β)+2[−(2Y₁²)²].

−β=(−2X₁)(2Y₁²),

X₃=α²−2β,

The resulting atomic blocks can be found in Table 1, taking as input X₁→R₁, R₂→Y₁, and Z₁→R₃, and returning as output X₃→R₁, Y₃→R₂, and Z₃→R₃.

TABLE 1
Atomic block formula for Jacobian doubling

| Sec. | Block 1 | Block 2 | Block 3 | Block 4 |
|---|---|---|---|---|
| S | R₄ ← R₃² | R₆ ← R₂² | R₄ ← R₁² | R₈ ← R₇² |
| | [Z₁²] | [Y₁²] | [α²] | [4Y₁⁴] |
| N | R₅ ← − R₄ | R₇ ← − R₁ | R₅ ← − R₁ | R₂ ← − R₈ |
| | [−Z₁²] | [−X₁] | [−α] | [−4Y₁⁴] |
| A | R₆ ← R₁ + R₄ | R₁ ← R₇ + R₇ | R₈ ← R₆ + R₆ | R₈ ← R₁ + R₆ |
| | [X₁ + Z₁²] | [−2X₁] | [−2β] | [X₃ − β] |
| A | R₄ ← R₁ + R₅ | R₇ ← R₆ + R₆ | R₁ ← R₄ + R₈ | R₄ ← R₂ + R₂ |
| | [X₁ − Z₁²] | [2Y₁²] | [X₃ = α² − 2β] | [−8Y₁⁴] |
| M | R₅ ← R₆R₄ | R₆ ← R₁R₇ | R₄ ← R₂R₃ | R₆ ← R₅R₈ |
| | [X₁² − Z₁⁴] | [−β] | [Y₁Z₁] | [−α(X₃ − β)] |
| A | R₄ ← R₅ + R₅ | R₁ ← R₅ + R₄ | R₃ ← R₄ + R₄ | R₂ ← R₆ + R₄ |
| | [2(X₁² − Z₁⁴] | [α] | [Z₃ = 2Y₁Z₁] | [Y₃] |

In table 1, it is possible to observe the operations being performed by each atomic block and their respective registers Ri. In this case, 8 registers are used. In addition, in order to eliminate “dummy” operations, the general algebraic substitution 3a=2a+a is used.

In the case of mixed addition (P+Q), the formulae and atomic blocks are shown in table 2, wherein 11 registers are used and the algebraic substitutions applied to eliminate the use of dummy operations are 2b³=(b²+b)²−(b⁴+b²). This last formula is correct when calculating the square of a Binomial on the right side of the equality, and it will be observed that this is the same with respect to the left side after eliminating some of the expressions having opposite signs. In addition, when it is required to calculate an expression of the type c=2a+b, this is calculated as c=(a+b)+a.

### Mixed Addition in Jacobian-Affine Coordinates

Given the points P=(X₁:Y₁:Z₁), in Jacobian coordinates, and Q=(X₂,Y₂), in affine coordinates, both on the elliptic curve E. To obtain a practical formula for block atomicity, two multiplications must be replaced with squarings, three of which are new, to get 6M+6S:

α=2(Z₁²Z₁Y₂)−2Y₁,

2β³=(β²+β)²−(β⁴+β²).

Z₃=(Z₁+β)²−(Z₁²+β²),

β=Z₁²X₂−X₁,

X₃=α²+2(−4X₁)β²−4β³,

Y₃=(−α)[(−4X₁β²)+X₃]+(2Y₁)(−4β³).

The resulting atomic blocks can be found in Table 2 with inputs X₁→R₁, Y₁→R₂, Z₁→R₃, X₂→R₄ and Y₂→R₅, and returning as output X₃→R₁, Y₃→R₂, and Z₃→R₃.

TABLE 2
Atomic block formula for mixed Jacobian-affine addition

| Sec | Block 1 | Block 2 | Block 3 |
|---|---|---|---|
| S | R₆ ← R₃² | R₄ ← R₁² | R₈ ← R₄² |
| | [Z₁²] | [β²] | [β⁴] |
| N | R₁ ← − R₁ | R₉ ← − R₂ | R₁₀ ← − R₁₀ |
| | [−X₁] | [−2Y₁] | [−(Z₁² + β²)] |
| A | R₂ ← R₂ + R₂ | R₁₀ ← R₆ + R₄ | R₁₂ ← R₄ + R₁ |
| | [2Y₁] | [Z₁² + β²] | [β² + β] |
| A | R₈ ← R₁ + R₁ | R₁₁ ← R₃ + R₁ | R₁ ← R₈ + R₄ |
| | [−2X₁] | [Z₁ + β] | [β⁴ + β²] |
| M | R₄ ← R₆R₄ | R₆ ← R₆R₃ | R₆ ← R₆R₅ |
| | [Z₁²X₂] | [Z₁³] | [Z₁³Y₂] |
| A | R₁ ← R₄ + R₁ | R₃ ← R₈ + R₈ | R₉ ← R₆+ R₉ |
| | [β] | [−4X₁] | [Z₁³Y₂ − 2Y₁] |
| Sec | Block 4 | Block 5 | Block 6 |
| S | R₈ ← R₁₂² | R₄ ← R₉² | R₃ ← R₁₁² |
| | [(β² + β)²] | [α²] | [(Z₁ + β)²] |
| N | R₁ ← − R₁ | R₁ ← − R₁ | R₂ ← − R₉ |
| | [−(β⁴ + β²)] | [−2β³] | [−α] |
| A | R₁ ← R₈ + R₁ | R₈ ← R₁ + R₁ | R₇ ← R₆ + R₁ |
| | [2β³] | [−4β³] | [−4X₁β² + X₃] |
| A | R₉ ← R₉ + R₆ | R₃ ← R₄ + R₃ | R₃ ← R₃ + R₁₀ |
| | [α] | [α² − 8X₁β² ] | [Z₃] |
| M | R₆ ← R₃R₄ | R₄ ← R₂R₈ | R₈ ← R₂R₇ |
| | [−4X₁β² ] | [−8Y₁β³ ] | [−α(−4X₁β² + X₃)] |
| A | R₃ ← R₆ + R₆ | R₁ ← R₃ + R₈ | R₂ ← R₈ + R₄ |
| | [−8X₁β² ] | [X₃] | [Y₃] |

For the case of tripling ([3]P), the formulae and atomic blocks are presented in Table 3 and 10 registers are used, wherein the algebraic substitutions thereof in order to eliminate dummy operations are:

3a=2a+a,

2a+b=(a+b)+a,

4ab=(2a+b²)²−(2a)²−(b²)²,y

12ab=(4ab+4ab)+4ab.

Point Tripling in Jacobian Coordinates.

Let P=(X₁:Y₁:Z₁) be a point on the elliptic curve E. To obtain the atomic blocks, one multiplication was transformed into a squaring, giving 8M+8S:

2β=[(2Y₁)²]²,

ω=3(4X¹Y₁²)−θ²,

2α=2θω,

Z₃=(2Z₁)ω,

X₃=4(4Y₁²)(2β−2α)+(4X₁ω²).

θ=3(X₁²−Z₁⁴)=3(X₁+Z₁²)(X₁−Z₁²),

4X₁ω²=(2X₁+ω²)²−(2X₁)²−(ω²)²,

ρ=(2α−2β)(4β−2α),

Y₃=2(−4Y₁)[ω²ω−ρ],

The resulting atomic blocks can be found in Table 3, taking as input X₁→R₁, Y₁→R₂, and Z₁→R₃, and returning as output X₃→R₁, Y₃→R₂, and Z₃→R₃.

TABLE 3
Atomic block formula for Jacobian tripling

| Sec | Block 1 | Block 2 | Block 3 | Block 4 |
|---|---|---|---|---|
| S | R₄ ← R₃² | R₅ ← R₅² | R₇ ← R₄² | R₇ ← R₅² |
| | [Z₁²] | [(2Y₁)²] | [θ²] | [2β] |
| N | R₅ ← − R₄ | R₂ ← − R₂ | R₇ ← − R₇ | R₄ ← − R₄ |
| | [−Z₁²] | [−Y₁] | [−θ²] | [−2α] |
| A | R₄ ← R₁ + R₄ | R₆ ← R₄ + R₄ | R₆ ← R₉ + R₆ | R₄ ← R₇ + R₄ |
| | [X₁ + Z₁²] | [2(X₁² − Z₁⁴] | [12X₁Y₁²] | [2β − 2α] |
| A | R₅ ← R₁ + R₅ | R₄ ← R₆ + R₄ | R₆ ← R₆ + R₇ | R₇ ← R₄ + R₇ |
| | [X₁ − Z₁²] | [θ] | [ω] | [4β − 2α] |
| M | R₄ ← R₄R₅ | R₆ ← R₁R₅ | R₇ ← R₆R₄ | R₅ ← R₅R₄ |
| | [X₁² − Z₁⁴] | [4X₁Y₁²] | [ωθ] | [4Y₁²(2β − 2α)] |
| A | R₅ ← R₂ + R₂ | R₉ ← R₆ + R₆ | R₄ ← R₇ + R₇ | R₅ ← R₅ + R₅ |
| | [2Y₁] | [8X₁Y₁²] | [2α] | [8Y₁²(2β − 2α)] |
| Sec | Block 5 | Block 6 | Block 7 | Block 8 |
| S | R₈ ← R₆² | R₁₀← R₈² | R₁ ← R₁² | R₇ ← R₃² |
| | [ω²] | [ω⁴] | [4X₁²] | [(2X₁ + ω²)²] |
| N | R₄ ← − R₄ | R₁₀ ← − R₁₀ | R₄ ← − R₄ | R₈ ← − R₁ |
| | [2α − 2β] | [−ω⁴] | [−ρ] | [−4X₁²] |
| A | R₅ ← R₅ + R₅ | R₁ ← R₁ + R₁ | R₈ ← R₈ + R₄ | R₁ ← R₈ + R₁₀ |
| | [16Y₁²(2α − 2β)] | [2X₁] | [ω³ − ρ] | [−4X₁² − ω⁴] |
| A | R₉ ← R₃ + R₃ | R₃ ← R₁ + R₈ | R₇ ← R₇ + R₂ | R₄ ← R₇ + R₁ |
| | [2Z₁] | [2X₁ + ω²] | [−4Y₁] | [4X₁ω²] |
| M | R₄ ← R₄R₇ | R₈ ← R₈R₆ | R₄ ← R₇R₈ | R₃ ← R₉R₆ |
| | [ρ] | [ω³] | [−4Y₁R₈] | [Z₃] |
| A | R₇ ← R₂ + R₂ | R₇ ← R₇ + R₂ | R₂ ← R₄ + R₄ | R₁ ← R₅ + R₄ |
| | [−2Y₁] | [−3Y₁] | [Y₃] | [X₃] |

Point Quintupling in Jacobian Coordinates.

Let P=(Xᵢ:Y₁:Z₁) be a point on the elliptic curve E. The formula of Mishra and Dimitrov [Mishra07] requires 15M+18S. This formula was improved by Longa and Miri [Longa-Miri08] to a balanced 11M+11S but these field operations cannot be fitted into sequences of (Sᵢ,Mᵢ) pairs. To obtain atomic blocks, the formula was re-balanced to 12M+12S (slightly less efficient, but with the possibility of being fit into 12 atomic blocks). Thus, the following formula was obtained:

2T=[(2Y₁)²]²,

E=3X₁(4Y₁²)+(−M²),

−E²=M²+2ME−(M+E)²

2U=(2Y₁+2L)²−(2Y₁)²−(2L)²,

N=V−(2L)²,

S=V²+16L⁴−3V(4L²),

Y₅=2(2Y₁)[2(−E³)S+2[−(2T)(2L)(16L⁴)]],

M=3(X₁+Z₁²)(X₁−Z₁²),

2L=2ME−2T,

16L⁴=[(2L)²]²,

V=(2T)(2L)+E(−E²),

2W=2EN=(E+N)²−E²−N²,

Z₅=(Z₁+V)²−Z₁²−V²,

X₅=4X₁V²−(2Y₁)(2U)(2W).

In the case of quintupling ([5]P), formulae and atomic blocks are presented in Table 4, wherein 15 registers are used. In addition to some of the previously exposed algebraic identities, two new algebraic identities are also applied to eliminate the use of dummy operations:

−12ab=−16ab+4ab,y

−E²=M²+2ME−(M+E)².

TABLE 4
Atomic block formula for Jacobian quintupling (operations and registers)

| Sec | Block 1 | Block 2 | Block 3 | Block 4 |
|---|---|---|---|---|
| S | R₄ ← R₃² | R₆ ← R₂² | R₁₀ ← R₈² | R₄ ← R₆² |
| N | R₅ ← − R₄ | R₇ ← − R₆ | R₁₁ ← − R₁₀ | R₆ ← − R₄ |
| A | R₆ ← R₁ + R₄ | R₈ ← R₄ + R₄ | R₉ ← R₉ + R₄ | R₁₄ ← R₁₁ + R₆ |
| A | R₄ ← R₁ + R₅ | R₈ ← R₄ + R₈ | R₉ ← R₉ + R₁₁ | R₈ ← R₉ + R₈ |
| M | R₄ ← R₆R₄ | R₄ ← R₁R₆ | R₄ ← R₈R₉ | R₆ ← R₄R₁₄ |
| A | R₂ ← R₂ + R₂ | R₉ ← R₄ + R₄ | R₁₁ ← R₄ + R₄ | R₄ ← R₁₁ + R₁₀ |
| Sec | Block 5 | Block 6 | Block 7 | Block 8 |
| S | R₁₀ ← R₈² | R₁₂ ← R₄² | R₁₄ ← R₁₄² | R₁₁ ← R₁₁² |
| N | R₁₁ ← − R₁₀ | R₁₅ ← − R₁₂ | R₃ ← − R₁₄ | R₁₅ ← − R₁₅ |
| A | R₈ ← R₄ + R₁₁ | R₅ ← R₁₅ + R₅ | R₇ ← R₃ + R₇ | R₁₁ ← R₁₁ + R₇ |
| A | R₁₁ ← R₂ + R₁₄ | R₁₃ ← R₃ + R₄ | R₃ ← R₄ + R₃ | R₇ ← R₉ + R₃ |
| M | R₁₀ ← R₉R₈ | R₃ ← R₁R₁₅ | R₄ ← R₄R₁₄ | R₁₁ ← R₁₂R₁₁ |
| A | R₄ ← R₆ + R₁₀ | R₁ ← R₃ + R₃ | R₁₅ ← R₄ + R₄ | R₉ ← R₁₅ + R₁₅ |
| Sec | Block 9 | Block 10 | Block 11 | Block 12 |
| S | R₁₅ ← R₁₄² | R₄ ← R₇² | R₁₀ ← R₃² | R₇ ← R₁₃² |
| N | R₁ ← − R₁ | R₁₄ ← − R₁₂ | R₁ ← − R₁₀ | R₆ ← − R₁₁ |
| A | R₁₄ ← R₁₂ + R₁₅ | R₁₅ ← R₁₄ + R₁₄ | R₉ ← R₈ + R₁ | R₈ ← R₇ + R₅ |
| A | R₄ ← R₉ + R₄ | R₁₄ ← R₁ + R₁ | R₇ ← R₁₂ + R₁₅ | R₁₂ ← R₄ + R₉ |
| M | R₁₂ ← R₆R₁₅ | R₉ ← R₁₀R₆ | R₇ ← R₂R₇ | R₁₂ ← R₆R₁₂ |
| A | R₆ ← R₁₄ + R₄ | R₁₂ ← R₉ + R₉ | R₂ ← R₇ + R₇ | R₁ ← R₁₄ + R₁₂ |

The corresponding algebraic operations being performed by each atomic block in order calculate [5]P are shown in Table 5. The formula takes as input X₁→R₁, Y₁→R₂, and Z₁→R₃, and returning as output X₃→R₁, Y₃→R₂, and Z₃→R₃.

TABLE 5
Atomic block formula for Jacobian quintupling (equivalences)

| Sec | Block 1 | Block 2 | Block 3 | Block 4 | Block 5 | Block 6 |
|---|---|---|---|---|---|---|
| S | [Z₁²] | [4Y₁²] | [M²] | [2T] | [(E + M)²] | [V²] |
| N | [−Z₁²] | [−4Y₁²] | [−M²] | [−2T] | [−(E + M)²] | [−V²] |
| A | [X₁ + Z₁²] | [2(X₁² − Z₁⁴)] | [3X₁ (2Y₁)²] | [2L] | [−E²] | [−V² − Z₁²] |
| A | [X₁ − Z₁²] | [M] | [E] | [E + M] | [2Y₁ + 2L] | [Z₁ + V] |
| M | [X₁² − Z₁⁴] | [4X₁ Y₁²] | [M E] | [4T L] | [−E³] | [−X₁ V²] |
| A | [2Y₁] | [8X₁ Y₁²] | [2M E] | [2M E + M²] | [V] | [−2X₁ V²] |

| Sec | Block 7 | Block 8 | Block 9 | Block 10 | Block 11 | Block 12 |
|---|---|---|---|---|---|---|
| S | [4L²] | [4(Y₁ + L)²] | [16L⁴] | [(E + N)²] | [N²] | [(Z₁ + V)²] |
| N | [−4L²] | [−8V L²] | [2X₁ V²] | [−64T L⁵] | [−N²] | [−4Y₁U] |
| A | [−4L² − 4Y₁²] | [2U] | [V² + 16L⁴] | [−128T L⁵] | [−E² − N²] | [Z₅] |
| A | [N] | [E + N] | [−12V L²] | [4X₁ V²] | [Y₅/4Y₁] | [2W] |
| M | [4V L²] | [4Y₁U] | [64T L⁵] | [−E³ S] | [Y₅/2] | [−8Y₁UW] |
| A | [8V L²] | [−16V L²] | [S] | [−2E³ S] | [Y₅] | [X₅] |

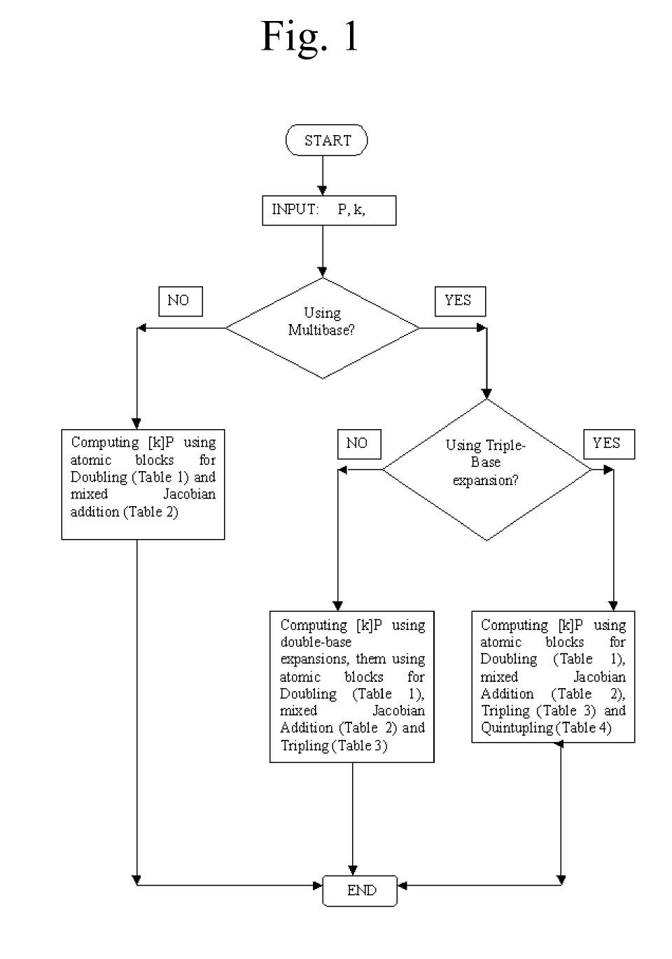

FIG. 1 shows how to use the different atomic blocks of the present invention. The cryptographic algorithm based on elliptic curves in the scalar multiplication [k]P is generally implemented by means of left-to-right algorithms, since it uses only one register which implies improvements in the performance when requiring less memory.

FIG. 1 shows the system and the atomic blocks that must be used for a cryptosystem implemented by means of left-to-right algorithms. For different cases, the first one being when the device does not use a multi-basis and the other cases in which double multi-basis or triple multi-basis are used. For further details as how to use the atomic blocks in the multi-basis, see papers published by [Dimitrov05, Mishra07].

### Comparison Among Different Countermeasures

Table 6 shows how the atomic blocks of this invention have improved their performance for the left-to-right case in comparison with papers published by [Longa08]. As can be seen, the atomic blocks of the present invention are more efficient and considering that the invention also presents an improvement in relation to the safety aspects. This efficiency is based on the fact that there are less operations on the defining fields of the elliptic curve, particularly having less additions (A) and negations (N).

TABLE 6
Cost of the atomic blocks

| Operations | Previous work [Longa08] | This work |
|---|---|---|
| Doubling | 4M + 4S + 16A + 8N | 4M + 4S + 12A + 4N |
| Mixed Addition | 6M + 6S + 24A + 12N | 6M + 6S + 18A + 6N |
| Tripling | 8M + 8S + 32A + 16N | 8M + 8S + 24A + 8N |
| Quintupling | | 12M + 12S + 36A + 12N |

Besides offering increased security, the atomic blocks of this invention are slightly more compact than those of Longa and Miri [Longa08].

Assuming experimental average ratios to multiplications of S/M≈0.8, A/M≈0.2 and N/M≈0.1 in [Giraud10], each of the atomic block takes ≈2.5M compared to ≈2.8M for those of Longa and Miri. This represents savings close to 10% on the whole scalar multiplication, both in double-and-add algorithms and multi-basis (2, 3, and 5) scalar multiplications.

In table 7 are shown the computational costs of the different existing countermeasures for simple side-channel attacks and as can be seen, the atomic blocks of the present invention for the left-to-right case is the most efficient countermeasure. When considering I=100M, S=0.8M. In [Giraud10]

The binary representation of k is denoted by k=(kₙ₋₁, . . . , k₂, k₁, k₀)₂. The following table summarizes the cost of the different regular multiplication algori

TABLE 7
Comparison of the different regular multiplication algorithm

| | Coordinate | Total | Performance |
|---|---|---|---|
| Countermeasure | Systems | Cost | n = 192 |
| Unified Formulas | [symbol] | η(13M + 5S) + 1L + 2M | 3366M |
| Weierstrass | [symbol] | η(16M + 3S) + 1L + 2M | 3634.8M |
| curves | | | |
| Double- and- | [symbol] | η(10M + 9S) + 1L + 3M + 1S^{(a)} | 3406.2M |
| Add- Always | | | |
| Montgomery | [symbol] | η(8M + 6S) + 1L + 1M^{(b)} | 2558.6M |
| Ladder Weier- | | | |
| strass curves | | | |
| Joye's double- | [symbol] | η(9M + 7S) + 1L + 9M + 6S^{(c)} | 2889.4M |
| add | | | |
| Signed-digit | [symbol] | η(9M + 7S) + 1L + 9M + 6S^{(d)} | 2889.4M |
| algorithm | | η(8M + 6S) + 1L + 5M + 4S^{(e)} | 2549.4M |
| Atomic Blocks | [symbol] | η(7M + 7S) + 1L + 3M + 1S^{(f)} | 2523M |

^{(a)}Using Fast Mixed Addition and Fast Point Doubling (a = −3) in [Longa08].
^{(b)}(X,Y)-only co-Z Montgomery ladder in [Goundar11]
^{(c)}Co-Z Joye's double-add in [Goundar11]
^{(d)}Co-z signed-digit algorithm right-to-left in [Goundar11]
^{(e)}(X,Y)-only co-Z signed-digit algorithm left-to-right in [Goundar11]
^{(f)}Atomic Blocks left-to-right the present invention.

The formulae presented in the current invention were implemented in the Magma software for verifying its proper performance. Its mathematical performance was analyzed in comparison to the other existing countermeasures and it was obtained a more efficient solution with respect to what exists in the state of the art for the case of using left-to-right algorithms in the scalar multiplication of a cryptosystem based on elliptic curves.

Although embodiments of the invention have been shown and described, it is to be understood that various modifications, substitutions, and rearrangements of parts, components, and/or process (method) steps, as well as other uses, shapes, construction, and design of the method for complete atomic blocks for elliptic curves in Jacobian coordinates over prime fields countermeasure for simple-side channel attacks and c-safe-fault attacks for left-to-right algorithms can be made by those skilled in the art without departing from the novel spirit and scope of this invention.

1. Atomic blocks to protect cryptosystems against simple side-channel attacks (SSCA) and C-Safe fault attacks, CHARACTERIZED in that they comprise eliminating the use of dummy operations in the atomic blocks used in the scalar multiplication ([d]P), which are based on elliptic curves defined on fields of prime characteristic, wherein the curves are of the type y²=x³−3x+b with bεGF(p) and the discriminate is Δ=−108+27b²≠0(mod p).

2. The atomic blocks according to claim 1, CHARACTERIZED in that special algebraic substitutions are used for writing formulae of: doubling ([2]P), mixed addition (P+Q), tripling ([3]P) and quintupling ([5]P), having an efficient structure of atomic block (S, N, A, A, M, A) when the scalar multiplication ([d]P) is implemented with left-to-right algorithms.

3. The atomic blocks according to claim 1, CHARACTERIZED in that they comprise balancing the number of squarings (S) and multiplications (M) by using the method presented in [Longa08] y [Bernstein07], besides algebraic substitutions to eliminate the use of “dummy” operations which may be subject to C-fault attacks.

4. The atomic blocks according to claim 3, CHARACTERIZED in that they comprise creating ordered pairs (Sᵢ,Mᵢ), wherein Sᵢ is a squaring followed by a multiplication Mᵢ per each atomic block.

5. The atomic blocks according to claim 1, CHARACTERIZED in that they comprise enumerating the minimum quantity of additions and negations required in each formula and determining each position thereof based on a data dependency graph.

6. The atomic blocks according to claim 2, CHARACTERIZED in that the first and last atomic blocks have less flexibility in the formula.

7. The atomic blocks according to claim 2, CHARACTERIZED in that they comprise determining the most compact and efficient structure of the atomic blocks.

8. The atomic blocks according to claim 7, CHARACTERIZED in that the most compact and efficient structure is the atomic structure (S, N, A, A, M, A).

9. The atomic blocks according to claim 2, CHARACTERIZED in that they comprise using the Left-to-right algorithm in the scalar multiplication ([d]P), writing formulae and atomic blocks for the case of doubling ([2]P), performing the operations between each atomic block and their respective registers Rᵢ and filling the “dummy operations” by means of general algebraic substitution 3a=2a+a.

10. The atomic blocks according to claim 2, CHARACTERIZED in that in the mixed addition (P+Q) are used 11 registers wherein the algebraic substitutions applied to eliminate the use of dummy operations are 2b³=(b²+b)²−(b⁴+b²); and also comprising the calculation of an expression of the type c=2a+b as c=(a+b)+a.

11. The atomic blocks according to claim 2, CHARACTERIZED in that for the case of tripling ([3]P) 10 registers are used wherein their algebraic substitutions to eliminate the dummy operations are 3a=2a+a, 2a+b=(a+b)+a, 4ab=(2a+b²)²−(2a)²−(b²)² y 12ab=(4ab+4ab)+4ab.

12. The atomic blocks according to claim 2, CHARACTERIZED in that for the case of quintupling ([5]P), 15 registers are used wherein the algebraic identities −12ab=−16ab+4ab, 3a=2a+a, and −E²=M²+2ME−(M+E)² are the ones applied to eliminate the use of dummy operations.

13. Method to protect cryptosystems against simple side-channel attacks (SSCA) and C-Safe fault attacks, CHARACTERIZED in that use the atomic blocks of the claim 1.
